(19) United States
(12) Patent Application Publication
(10) Pub. No.: US 2026/0013010 A1
(43) Pub. Date: Jan. 8, 2026

(54) PTC Heating Device and Electric Heating Device

(71) Applicant: Eberspächer catem GmbH & Co. KG, Herxhelm (DE)

(72) Inventor: Simon Georg Kräck, Karlsruhe (DE)

(21) Appl. No.: 19/257,809

(22) Filed: Jul. 2, 2025

(30) Foreign Application Priority Data
Jul. 3, 2024 (DE) 102024118899.5

(51) Int. Cl. H05B 3/26

(52) U.S. Cl. CPC H05B 3/267

(57) ABSTRACT

A PTC heating device has at least one PTC element and conductor tracks which are electrically conductively connected to the PTC element and which are assigned different polarities for energizing the PTC element. An insulating material at least partially surrounds the PTC element. The insulating material comprises a polymer or copolymer having at least one aromatic ring in the backbone of the polymer. Also provided is an electric heating device having a heating chamber and a connection chamber which is separated from the heating chamber by a partition wall, from which at least one heating rib projects in the direction of the heating chamber. The connection chamber forms a receiving pocket in which a PTC heating device that is electrically connected in the connection chamber is received. The PTC device is coupled in a thermally conductive manner to inner walls of the heating rib delimiting the receiving pocket.

### BACKGROUND OF THE INVENTION

### 1. Field of the Invention

The present invention relates to a PTC heating device having at least one PTC element and conductor tracks, which are electrically conductively connected to the PTC element and are assigned different polarities for energizing the PTC element, and having an insulating material at least partially surrounding the PTC element.

### 2. Background of the Invention

Such a PTC heating device is known, for example, from DE 10 2019 204 401 A1 and its US counterpart U.S. Pat. No. 11,737,174, the subject matter of which is incorporated herein by reference. The basic design can also be an embodiment of the PTC heating device according to the invention.

In this state of the art, a frame is formed from an insulating plastic material around the PTC element and the conductor tracks, in which the plastic material forming the frame is injection-molded to seal in the conductor tracks and the PTC element as well as insulating plates. In this state of the art, the conductor tracks are arranged in the form of contact bars on opposite edge surfaces of the cuboid PTC element. Accordingly, the PTC element is at least partially surrounded by the insulating plastic material with these conductor tracks interposed.

Another state of the art, which can also be an implementation of the solution according to the present proposal in terms of its general design details, is known from DE 10 2020 208 643 A1 (and its US counterpart U.S. Pat. No. 12,150,217) and DE 10 2021 112 690 A1 (and its US counterpart U.S. Pat. No. 12,049,124), respectively, the subject matter of all of which is incorporated herein by reference. In this prior art, a plastic frame is produced into which the at least one PTC element is inserted. As conductor tracks connection tongues protruding beyond the frame at the ends are provided, which directly contact the opposite main side surfaces of the PTC element. Metallization is applied to the PTC element to distribute the power current evenly over the main side surface of the PTC element. The main side surfaces of the PTC element that extract the heat are in contact with an insulating layer made of ceramic.

In the solution known from DE 10 2021 112 690 A1 and its US counterpart, several PTC elements are inserted into an insulating frame made of a plastic material and electrically contacted on opposite main side surfaces with a contact plate. An insulating layer made of ceramic is provided on the outside of each of these contact plates. According to the state of the art, these different layers are placed in a metallic receiving pocket, which is deformed after insertion so that the main side surfaces of the metallic receiving pocket, which extract the heat, are coupled to the main side surfaces of the PTC element in a way that ensures good thermal conductivity.

In this prior art, the PTC heating device is designed as a plug-in element, as in the solution known from DE 10 2019 204 401 A1 and its US counterpart, which can be inserted into a receiving pocket of a partition wall of an electric heating device. This partition wall of the electric heating device separates a heating chamber for heating a fluid from a connection chamber in which the PTC heating device is electrically connected and which can also have a control device according to the present invention, which serves to control the PTC heating device or devices of the electric heating device.

An electric heating device and a PTC heating device, which is inserted into a receiving pocket of the PTC heating device, which projects into the heating chamber as a heating rib and is clamped in the receiving pocket via a wedge, are known from EP 2 440 006 A1 and its US counterpart U.S. Pat. No. 9,119,232, incorporated herein by reference. Although here, too, the at least one PTC heating element is accommodated in a frame made of an insulating plastic material and inserted into the receiving pocket in this way together with the contact plates and insulating layers, solutions are also known in which the PTC element is inserted into the receiving pocket with insulation on the main side surfaces, but nevertheless exposed on the edge surfaces; see EP 3 101 998 A1 and its US counterpart U.S. Pat. No. 10,485,059, incorporated herein by reference. In this case, a casting compound can provide electrical insulation from the metal outer walls of the receiving pocket and also improved heat extraction from the edge surfaces of the PTC element. Such a casting compound can also be an insulating material within the meaning of the present invention, which at least partially surrounds the PTC element.

PTC heating devices and electric heating devices of the type mentioned at the beginning are used in the prior art and also preferably according to the present invention as electric heating devices in a vehicle. In the absence of waste heat due to the combustion of fuel, such electric heating devices are regularly used in electrically powered vehicles. In contrast to vehicles with internal combustion engines, in which the electric heating devices are usually operated with the voltage of the battery and thus with 12 V, the PTC heating devices in electrically powered vehicles can be operated with a current that has a significantly higher voltage. In such applications, the requirements for dielectric strength and clearance and creepage distances are increased.

### SUMMARY OF THE INVENTION

The present invention is based on the problem of providing a PTC heating device and an electric heating device comprising at least one of these PTC heating devices, in which the PTC element is protected against electric flashovers in an improved manner.

To solve this problem, the present invention proposes a PTC heating device having at least one PTC element and conductor tracks which are electrically conductively connected to the PTC element and are assigned different polarities for energizing the PTC element, and having an insulating material at least partially surrounding the PTC element, in which the insulating material comprises a polymer or copolymer with at least one aromatic ring in the backbone of the polymer.

In the solution according to the invention, the PTC element is usually a ceramic element, which is provided with a metallization at least partially, usually over its entire surface on opposite sides. This metallization can function as a conductor track in the sense of the present invention, either in whole or in part. Usually, however, a separate conductor element, for example a contact plate, is provided as a conductor track. In this case, two such contact plates are usually electrically conductively contacted with the at least one PTC element, which also enable connection lugs for the electrical connection of the PTC heating device in the connection chamber.

The insulating material according to the present invention can fully surround the PTC element in the manner of a frame. The frame can be prefabricated so that the PTC element is inserted into the previously formed frame and usually connected to this frame to obtain a pre-assembled PTC heating device. The frame usually also adds the conductive tracks or contact plates, which are regularly placed on opposite main sides of the PTC element and the metallization applied there. In this solution, the conductive tracks may be joined together with the PTC element by the frame to form a single unit. This unit can be the PTC heating device within the meaning of the present invention. The unit can additionally have insulating layers, for example in the form of ceramic plates and/or foils or foil sections, via which the PTC heating device is electrically insulated on the outside and thus exposed to potential.

The insulating material can also be a casting compound which completely or partially surrounds the PTC element after the PTC element has been placed in a receiving pocket and the casting compound has been poured into the receiving pocket. Such a casting compound can also be an insulating material within the meaning of the present invention.

The insulating material according to the present invention comprises a polymer or copolymer having at least one aromatic ring in the backbone of the polymer. The polymer or copolymer may comprise a polyaryletherketone, an aramid (aromatic polyamide), a polyamideimide, a polyetherimide or a polyphenylene. The polyaryletherketone may be polyether ether ketone (PEEK), polyether ether ether ketone (PEEEK), polyether ether ketone ketone (PEEKK) or polyether ketone ether ketone ketone (PEKEKK), such as poylether ether ketone (PEEK). The aramid may be a polyphthalamide (PPA), such as poly (m-phenylene terephthalamide) or poly (p-phenylene terephthalamide) (PPTA). Preferably, the polyphenylene is poly-p-phenylene. The melting temperature of the polymer or copolymer is particularly may be greater than 300° C.

### BRIEF DESCRIPTION OF THE DRAWINGS

Further details and advantages of the present invention can be seen from the following description of an embodiment in conjunction with the drawing. In this show:

FIG. 1 a perspective side view of an embodiment of an electric heating device and

FIG. 2 an exploded perspective view of an example of an electric PTC heating device.

### DETAILED DESCRIPTION

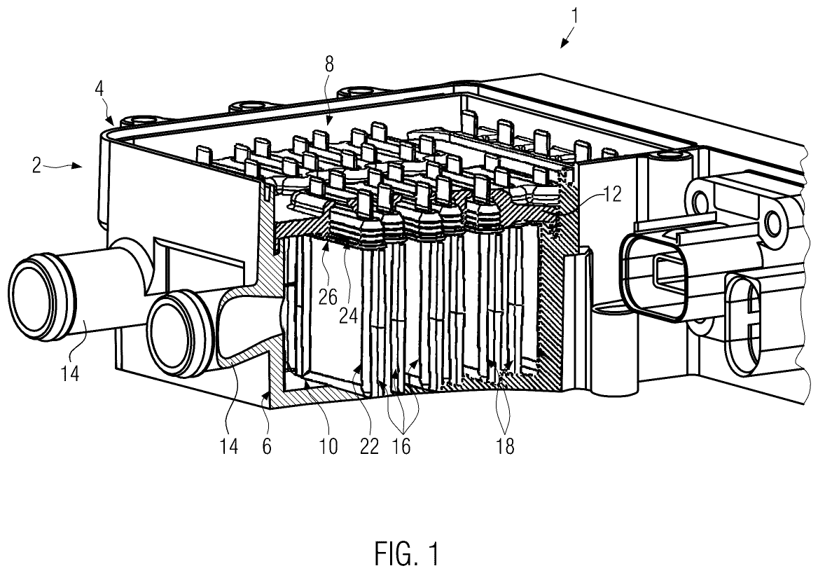

In FIG. 1, reference sign 1 indicates an electric heating device with a housing 2 with an upper housing part 4 and a lower housing part 6. The upper housing part 4 surrounds a connection chamber 8. The lower housing part 6 surrounds a heating chamber 10. A partition wall 12 is located between the heating chamber 10 and the connection chamber 8. The partition wall 12 is fluid-tight, so that liquid fluid contained in the heating chamber 10, which is to be heated, cannot reach the connection chamber 8. At the level of the heating chamber 10, the housing 2 is surmounted by connecting pieces 14, which are used to connect fluid-carrying lines within a motor vehicle.

Reference sign 16 indicates a PTC heating device, which projects into the heating chamber 10 as a heating rib 18 and has a U-shaped device housing 22, which is closed on the underside and forms a receiving pocket 20, which is in plug contact with the partition wall 12 and is received therein in a sealed manner.

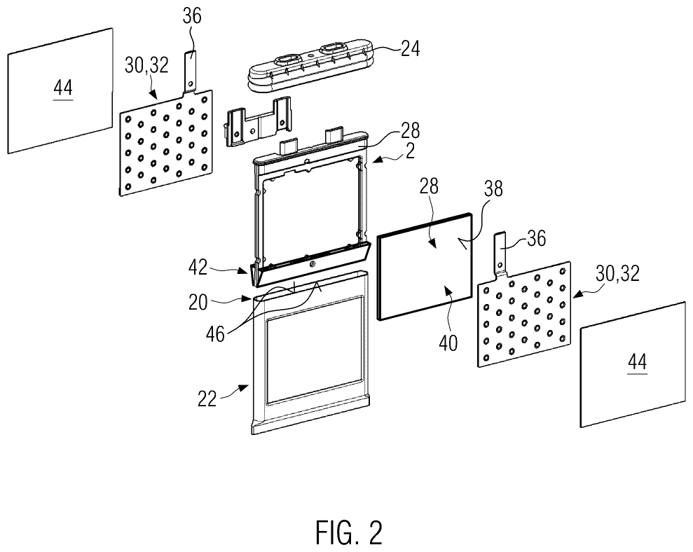

As FIG. 2 illustrates, a sealing collar 24 is associated with the device housing 22 for this purpose, which seals against the device housing 22 and a plug-in receptacle of the partition wall 12, marked with reference sign 26 in FIG. 1.

A PTC element 28 is arranged in each device housing 22, which is arranged between conductor tracks 30 in the form of contact plates 32, which are in electrically conductive contact with the respective PTC element 28 as conductor tracks 34 and form connection lugs 36, which are electrically conductively connected in the connection chamber 8.

The PTC element 28 is cuboidal in shape and has main side surfaces 38, which are provided with a metallization 40, each of which is in direct electrically conductive contact with the associated contact plate 32. The PTC element 28 and the contact plates 32 are inserted into a frame 42, which is formed from the electrically insulating material according to the invention. On the outside of the respective contact plates 32 there are electrical insulating layers 44, formed by plates of an insulating material, such as ceramic. In the assembled state, these insulating layers 44 are in direct contact with the inner walls 46 of the heating rib 18 and thus, in the present case, in contact with the opposing inner surfaces of the heating device housing 22. For this purpose, the heating device housing formed from a sheet metal can be deformed after insertion of the PTC element 28 together with the layers 32, 44 in contact with both sides and the frame 42 in such a way that the inner walls 46 are in contact with the outer layer, i.e. in the present case the insulating layers 44, under prestress.

1. A PTC heating device comprising:
at least one PTC element;
conductor tracks which are electrically conductively connected to the PTC element and which are assigned different polarities for energizing the PTC element; and
an insulating material at least partially surrounding the PTC element, wherein the insulating material comprises a polymer or copolymer having at least one aromatic ring in a backbone of the polymer or copolymer.

2. The PTC heating device according to claim 1, wherein the conductor tracks are formed by contact plates which are on opposite sides in contact with a metallization applied to the PTC element, and wherein the PTC element is surrounded by a frame formed by the insulating material, which frame joins the contact plates while enclosing the PTC element.

3. The PTC heating device according to claim 1, wherein the polymer or copolymer comprises a polyaryletherketone, an aramid (aromatic polyamide), a polyamideimide, a polyetherimide, or a polyphenylene.

4. The PTC heating device according to claim 3, wherein the polyaryletherketone is polyether ether ketone (PEEK), polyether ether ether ketone (PEEEK), polyether ether ketone ketone (PEEKK), or polyether ketone ether ketone ketone (PEKEKK).

5. The PTC heating device according to claim 4, wherein the polymer is poly ether ether ketone (PEEK).

6. The PTC heating device according to claim 3, wherein the aramid is a polyphthalamide (PPA).

7. The PTC heating device according to claim 6, wherein the polyphthalamide is poly (m-phenylene terephthalamide) or poly (p-phenylene terephthalamide) (PPTA).

8. The PTC heating device according to claim 3, wherein the polyphenylene is poly-p-phenylene.

9. The PTC heating device according to claim 1, wherein the polymer or copolymer has a melting temperature greater than 300° C.

10. An electric heating device comprising:
a heating chamber;
a connection chamber which is separated from the heating chamber by a partition wall from which at least one heating rib projects in a direction of the heating chamber, wherein the heating rib forms a receiving pocket in which a PTC heating device is received, wherein
the PTC heating device is coupled in a thermally conductive manner to inner walls of the heating rib that delimit the receiving pocket; and wherein
the PTC heating device comprises
at least one PTC element;
conductor tracks which are electrically conductively connected to the PTC element and which are assigned different polarities for energizing the PTC element; and
an insulating material at least partially surrounding the PTC element, wherein the insulating material comprises a polymer or copolymer having at least one aromatic ring in a backbone of the polymer or copolymer.

11. The electric heating device according to claim 10, wherein the polymer or copolymer comprises a polyaryletherketone, an aramid (aromatic polyamide), a polyamideimide, a polyetherimide, or a polyphenylene.

12. The electric heating device according to claim 11, wherein the polyaryletherketone is polyether ether ketone (PEEK), polyether ether ether ketone (PEEEK), polyether ether ketone ketone (PEEKK), or polyether ketone ether ketone ketone (PEKEKK).

13. The electric heating device according to claim 12, wherein the polymer is poly ether ether ketone (PEEK).

14. The electric heating device according to claim 11, wherein the aramid is a polyphthalamide (PPA).

15. The electric heating device according to claim 10, wherein the polymer or copolymer has a melting temperature greater than 300° C.
